(19) United States
(12) Patent Application Publication
(10) Pub. No.: US 2011/0136015 A1
(43) Pub. Date: Jun. 9, 2011

(54) METHOD OF PRODUCING NEGATIVE ELECTRODE FOR NON-AQUEOUS ELECTROLYTE SECONDARY BATTERY, NEGATIVE ELECTRODE, AND NON-AQUEOUS ELECTROLYTE SECONDARY BATTERY USING THE SAME

(76) Inventors: Junichi Sugaya, Osaka (JP); Yoshiyuki Muraoka, Osaka (JP)

(21) Appl. No.: 13/058,426

(22) PCT Filed: Jun. 15, 2010
(86) PCT No.: PCT/JP2010/003963

§ 371 Date: Feb. 10, 2011

(30) Foreign Application Priority Data
Jun. 16, 2009 (JP) 2009-143500

(51) Int. Cl. H01M 4/583; H01M 4/04

(52) U.S. Cl. 429/231.8; 427/77

(57) ABSTRACT

A method of producing a non-aqueous electrolyte secondary battery of the present invention includes the steps of: (1) producing a negative electrode precursor by applying a negative electrode slurry including graphite particles and a binder onto a negative electrode core material and drying the same to form a negative electrode material mixture layer; and (2) producing a negative electrode by compressing while heating the negative electrode precursor at a temperature at which the binder softens. In the step (2), a temperature at which the negative electrode precursor is heated and a force with which the negative electrode precursor is compressed are controlled such that the compressed negative electrode material mixture layer in the negative electrode includes 1.5 g or more of the graphite particles per 1 cm³ of the negative electrode material mixture layer, and that an average circular degree of the graphite particles maintains 70% or more of an average circular degree of graphite particles in the negative electrode precursor.

### TECHNICAL FIELD

The present invention relates to a non-aqueous electrolyte secondary battery, and particularly relates to a method of producing a negative electrode including graphite particles as a negative electrode active material.

### BACKGROUND ART

A negative electrode for a non-aqueous electrolyte secondary battery represented by a lithium ion secondary battery includes generally graphite particles as a negative electrode active material.

This negative electrode is produced as follows. Graphite particles, a binder, and a conductive agent as necessary are mixed in the presence of a predetermined dispersing medium to prepare a negative electrode slurry. This negative electrode slurry is applied onto a negative electrode core material composed of a copper foil etc., and is then dried to form a negative electrode material mixture layer, thereby obtaining a negative electrode precursor. Subsequently, the negative electrode precursor is compressed with rolls to increase the density of the negative electrode material mixture layer and also to adhere closely the negative electrode material mixture layer to the negative electrode core material. Since the negative electrode material mixture layer integrated with a large negative electrode core material is an original plate including material for a plurality of negative electrodes, this is cut into a predetermined shape. Thus, negative electrodes for individual batteries are obtained.

When the charge and discharge of a battery including the above negative electrode are repeated, graphite particles repeat expansion and contraction. Consequently, the negative electrode material mixture layer may separate from the negative electrode core material to lower the cycle characteristics.

Therefore, Patent Literature 1 proposes to use graphite particles having an average circular degree of 0.93 or more with the aim of improving the cycle characteristics. According to this proposition, the adhesive strength of the negative electrode material mixture layer with the negative electrode core material can be increased.

### CITATION LIST

### Patent Literature

[PTL 1] Japanese Laid-Open Patent Publication No. 2002-216757

### SUMMARY OF INVENTION

### Technical Problem

In recent years, batteries having higher performance have been demanded, and batteries having higher capacity and higher energy density have been examined. To meet such demands, it is considered to increase the density of graphite particles in the negative electrode material mixture layer by increasing the linear pressure of the rolls during compression.

However, when the linear pressure of the rolls during compression is increased, graphite particles deform greatly during compression to decrease greatly the average circular degree even when graphite particles having a large average circular degree disclosed in Patent Literature 1 are used. Consequently, flat graphite particles having a large inner stress (distortion) are formed. When a battery having a negative electrode including such graphite particles is charged and discharged, the graphite particles not only change their shape because of expansion and contraction, but also change their shape greatly so as to relieve the large inner stress (distortion). As a result, the graphite particles become readily separable from the negative electrode core material to lower the charge/discharge cycle characteristics.

In order to solve the above conventional problem, the present invention has an object to provide a method of producing a negative electrode capable of suppressing deformation of the graphite particles during compression of the negative electrode precursor. Also, the present invention has an object to provide a non-aqueous electrolyte secondary battery having superior charge/discharge cycle characteristics and high capacity by using a negative electrode obtained by the above production method.

### Solution to Problem

A method of producing a negative electrode for non-aqueous electrolyte secondary battery includes the steps of:

(1) producing a negative electrode precursor by applying a negative electrode slurry including graphite particles and a binder onto a negative electrode core material and drying the same to form a negative electrode material mixture layer; and

(2) producing a negative electrode by compressing while heating the negative electrode precursor at a temperature at which the binder softens,

wherein, in the step (2), a temperature at which the negative electrode precursor is heated and a force with which the negative electrode precursor is compressed are controlled such that the compressed negative electrode material mixture layer in the negative electrode includes 1.5 g or more of the graphite particles per 1 cm³ of the negative electrode material mixture layer, and that an average circular degree of the graphite particles maintains 70% or more of an average circular degree of graphite particles in the negative electrode precursor.

Also, the present invention relates to a negative electrode for non-aqueous electrolyte secondary battery, including:

a negative electrode core material; and

a compressed negative electrode material mixture layer including graphite particles and a binder on the negative electrode core material,

wherein the negative electrode material mixture layer includes 1.5 g or more of the graphite particles per 1 cm³ of the negative electrode material mixture layer, and

an average circular degree of the graphite particles maintains 70% or more of that before compression.

### EFFECT OF INVENTION

### Advantageous Effects of Invention

According to the present invention, since deformation of the graphite particles is suppressed during compression of the negative electrode precursor, deterioration of the charge/discharge cycle characteristics caused by deformation of the graphite particles is suppressed.

During compression of the negative electrode precursor, since it is possible to soften and deform the binder by heating the negative electrode precursor, the binder can readily penetrate between the graphite particles (slip properties are improved) even with a low pressure, thereby improving greatly the binding properties between the graphite particles.

By using the negative electrode of the present invention, a highly reliable non-aqueous electrolyte secondary battery having superior charge/discharge cycle characteristics is obtained.

While the novel features of the invention are set forth particularly in the appended claims, the invention, both as to organization and content, will be better understood and appreciated, along with other objects and features thereof, from the following detailed description taken in conjunction with the drawings.

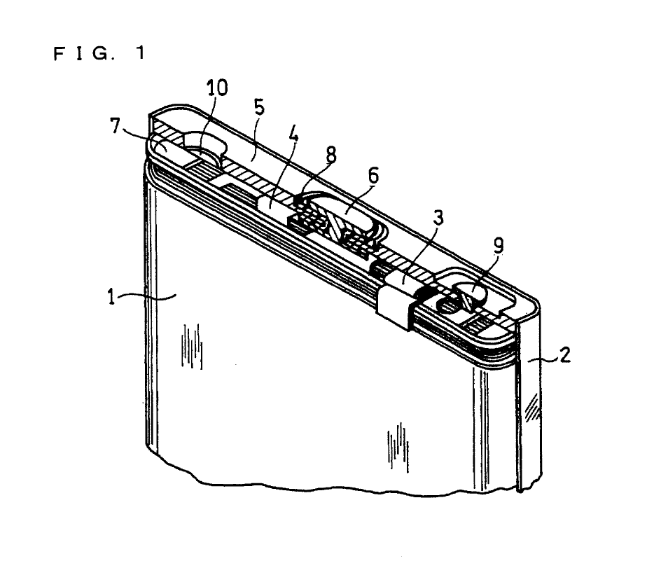

### BRIEF DESCRIPTION OF DRAWING

[FIG. 1] A partially cutout perspective view of a prismatic lithium ion secondary battery in accordance with an example of the present invention.

### DESCRIPTION OF EMBODIMENT

A method of producing a negative electrode for non-aqueous electrolyte secondary battery includes the steps of: (1) producing a negative electrode precursor by applying a negative electrode slurry including graphite particles and a binder onto a negative electrode core material and drying the same to form a negative electrode material mixture layer; and (2) producing a negative electrode by compressing while heating the negative electrode precursor at a temperature at which the binder softens. In the step (2), a temperature at which the negative electrode precursor is heated and a force with which the negative electrode precursor is compressed are controlled such that the compressed negative electrode material mixture layer in the negative electrode includes 1.5 g or more of the graphite particles per 1 cm³ of the negative electrode material mixture layer, and that an average circular degree of the graphite particles maintains 70% or more of an average circular degree of graphite particles in the negative electrode precursor.

That is, the temperature at which the negative electrode precursor is heated and the force with which the negative electrode precursor is compressed are controlled such that the weight of the graphite particles included per 1 cm³ of the negative electrode material mixture layer is 1.5 g or more after the step (2), and that the decrease ratio of the average circular degree of the graphite particles after the step (2) relative to the average circular degree of the graphite particles before the step (2) (the decrease ratio of the average circular degree of the graphite particles during compression, hereinafter) is 30% or less.

Herein, the graphite particles are particles including a layered structure of linked six carbon rings, and examples thereof include particles of natural graphite, artificial graphite, and graphitized mesophase carbon.

In the conventional method of compressing the negative electrode precursor only once without heating the negative electrode precursor, it is necessary to compress with a large linear pressure for ensuring the binding properties of the negative electrode material mixture layer. When the negative electrode material mixture layer is compressed to a high density to an extent that the weight of the graphite particles included per 1 cm³ of the negative electrode material mixture layer is about 1.5 g, the decrease ratio of the average circular degree of the graphite particles exceeds 30% and the graphite particles deform greatly. Consequently, the inner stress of the graphite particles increases. Therefore, the graphite particles change their shape greatly while repeating expansion and contraction along with the charge and discharge, thereby to become readily separable from the negative electrode core material, deteriorating significantly the charge/discharge cycle characteristics.

Meanwhile, as in the present invention, in the case where the negative electrode precursor is compressed while being heated at a temperature at which the binder softens, the pressure to apply to the negative electrode precursor during compression can be decreased. At the same time, since the binder deforms readily, the binder penetrates readily between the graphite particles. Therefore, the binding properties between the graphite particles are improved greatly, and thus the negative electrode material mixture layer can be integrated firmly with the negative electrode core material. Consequently, it is possible to obtain readily and surely the negative electrode material mixture layer having an intended thickness of the negative electrode and an intended density of the graphite particles, and also having superior binding properties between the graphite particles by one compression step. Even in the case where the weight of the graphite particles included per 1 cm³ of the negative electrode material mixture layer is 1.5 g or more, deformation of the graphite particles is suppressed, and the decrease ratio of the average circular degree of the graphite particles can be suppressed to 30% or less. According to the present invention, it is possible to obtain a negative electrode having high capacity and high energy density in which the weight of the graphite particles included per 1 cm³ of the negative electrode material mixture layer is 1.5 g or more without deteriorating the charge/discharge cycle characteristics. According to the present invention, it is possible to realize an extremely high filling density of the graphite particles, that is, the weight of the graphite particles included per 1 cm³ of the negative electrode material mixture layer is 1.6 g or more, which could not have been obtained by the conventional method.

The decrease ratio of the graphite particles during compression is preferably 20% or less. When the decrease ratio of the average circular degree of the graphite particles during compression is 20% or less, the charge/discharge cycle characteristics can be improved greatly. The weight of the graphite particles included per 1 cm³ of the negative electrode material mixture layer is preferably 1.7 g or less. When the weight of the graphite particles included per 1 cm³ of the negative electrode material mixture layer exceeds 1.7 g, the Li acceptance of the negative electrode lowers, and therefore Li may be deposited on the negative electrode surface during the charge.

The circular degree is an index representing the form of a particle and is determined by the formula as follows. It is meant that when the circular degree is 1, the particle is a true sphere, and as the circular degree is close to 1, the particle has a form close to the true sphere.

Circular degree=(circumference of a circle having the same surface area as the two-dimensional projected image of a particle)/(effective circumference of the two-dimensional projected image of the particle)

The average circular degree can be measured by image processing of a cross section of the negative electrode with a scanning electron microscope (SEM). Herein, circular degrees of any 100 particles having an equivalent circle diameter corresponding to the average particle diameter are determined, and an average value thereof is determined. The equivalent circle diameter is a diameter of a circle having the same surface area as the surface area of the two-dimensional projected image of a particle.

The decrease ratio of the average circular degree of the graphite particles during compression is determined by the following formula:

Decrease ratio of the average circular degree of the graphite particles during compression (%)=(average circular degree of the graphite particles before compression−average circular degree of the graphite particles after compression)/(average circular degree of the graphite particles before compression)×100

The average particle diameter of the graphite particles after compression is preferably 10 to 30 μm. When the average particle diameter of the graphite particles exceeds 30 μm, the reactivity of the graphite particles with lithium during the charge may lower. When the average particle diameter of the graphite particles is less than 10 μm, the specific surface area thereof may become too large to increase irreversible capacity. More preferably, the average particle diameter of the graphite particles is 15 to 25 μm.

Herein, the average particle diameter means a median diameter (D50) in volume particle size distribution of the negative electrode active material. The volume particle size distribution of the negative electrode active material can be measured by a commercially available laser diffraction particle size distribution measuring apparatus (e.g. LA-920 manufactured by HORIBA, Ltd.).

The average circular degree of the graphite particles after compression is preferably 0.5 or more. When the average circular degree of the graphite particles after compression is less than 0.5, orientation of the graphite particles caused by the compression may increase to lower the reactivity of the graphite particles with lithium. More preferably, the average circular degree of the graphite particles after compression is 0.7 or more.

In order to have an average circular degree of the graphite particles after compression of 0.5 or more, the average circular degree of the graphite particles before compression is preferably 0.7 or more in view of the degree of decrease of the average circular degree of the graphite particles during compression.

The step (2) is a step of pressing the negative electrode precursor by using a heat plate, or passing the negative electrode precursor through a pair of heat rolls. By performing this step once, the negative electrode material mixture layer can be closely adhered to and integrated with the negative electrode core material.

In the case where the negative electrode obtained in the step (2) includes a negative electrode core material composed of a metal foil and negative electrode material mixture layers formed on both surfaces of the negative electrode core material, the total thickness of the negative electrode is 100 to 300 μm, for example. The thickness per one surface of the negative electrode material mixture layer is 46 to 146 μm, for example, and preferably 60 to 80 μm.

In the case where the negative electrode material mixture layers are formed on both surfaces of the negative electrode core material, the compression ratio (ratio of the thickness of the negative electrode material mixture layer in the negative electrode after compression relative to the thickness of the negative electrode material mixture layer in the negative electrode precursor before compression) in the step (2) is preferably 50 to 70%.

The force (linear pressure) with which the negative electrode precursor is compressed in the step (2) is preferably 1×10² to 3×10² kgf/cm. When the linear pressure is 1×10² kgf/cm or more, superior binding properties can be obtained between the graphite particles, and between the negative electrode material mixture layer and the negative electrode core material even with one compression. When the linear pressure is 3×10² kgf/cm or less, deformation of the graphite particles can be suppressed greatly.

In order to obtain more favorable charge/discharge cycle characteristics, the linear pressure is more preferably 1×10² to 2×10² kgf/cm.

The temperature at which the negative electrode precursor is heated in the step (2) is preferably a temperature at which the elastic modulus of the binder is 30% or less of the elastic modulus of the binder at 25° C. The binder preferably has elastic modulus at 25° C. of 0.5×10³ to 3×10³ MPa. The elastic modulus of styrene-butadiene rubber (SBR) at 25° C. is 1.7×10³ MPa.

The elastic modulus is an index representing difficulty to deform, and when the elastic modulus lowers, deformation readily occurs. When the negative electrode precursor is compressed while being heated to the above temperature, the binder softens and deforms readily, and the binder penetrates readily between the graphite particles, thereby improving the binding properties between the graphite particles.

In order to make the binder exist uniformly in the negative electrode material mixture layer, the heating temperature in the step (2) is more preferably a temperature at which the elastic modulus of the binder is 0.05% or more of the elastic modulus of the binder at 25° C. When the heating temperature in the step (2) is a temperature at which the elastic modulus of the binder is less than 0.05% of the elastic modulus of the binder at 25° C., the negative electrode capacity may lower. The reason for this is considered that, in the negative electrode material mixture layer, the portion at which the whole surface of the graphite particles is covered closely with the binder increases, thereby lowering the lithium acceptance of the graphite particles.

The temperature at which the elastic modulus of the binder is 30% or less of the elastic modulus of the binder at 25° C. is 50 to 100° C., for example. Therefore, the heating temperature in the step (2) is preferably 50 to 100° C. One example of the binder having an elastic modulus at 50 to 100° C. of 30% or less of an elastic modulus at 25° C. is SBR.

During compression in the step (2), when the heating temperature is 50 to 100° C. and the linear pressure is 1×10² to 3×10² kgf/cm, the decrease ratio of the average circular degree of the graphite particles during compression can be reduced to about 10%.

The content of the binder in the negative electrode material mixture layer is preferably 0.5 to 3 parts by weight per 100 parts by weight of the graphite particles. More preferably, the content of the binder in the negative electrode material mixture layer is 0.5 to 2 parts by weight per 100 parts by weight of the graphite particles.

As the binder, material used is one capable of being used in the non-aqueous electrolyte secondary battery and having an elastic modulus satisfying the above conditions; that is, the elastic modulus at 25° C. is 0.5×10³ to 3×10³ MPa, and the elastic modulus at 50 to 100° C. is 0.05 to 30% of the elastic modulus at 25° C.

Specific examples of the binder include polyethylene, polypropylene, polytetrafluoroethylene (PTFE), polyvinylidene fluoride (PVDF), styrene-butadiene rubber (SBR), tetrafluoroethylene-hexafluoropropylene copolymer (FEP), tetrafluoroethylene-perfluoroalkyl vinyl ether copolymer (PFA), vinylidene fluoride-hexafluoropropylene copolymer, vinylidene fluoride-chlorotrifluoroethylene copolymer, ethylene-tetrafluoroethylene copolymer (ETFE resin), polychlorotrifluoroethylene (PCTFE), vinylidene fluoride-pentafluoropropylene copolymer, propylene-tetrafluoroethylene copolymer, ethylene-chlorotrifluoroethylene copolymer (ECTFE), vinylidene fluoride-hexafluoropropylene-tetrafluoroethylene copolymer, vinylidene fluoride-perfluoromethyl vinyl ether-tetrafluoroethylene copolymer, ethylene-acrylic acid copolymer or (Na⁻) ion cross-linked copolymer thereof, ethylene-methacrylic acid copolymer or (Na⁺) ion cross-linked copolymer thereof, ethylene-methyl acrylate copolymer or (Na⁺) ion cross-linked copolymer thereof, ethylene-methyl methacrylate copolymer or (Na⁺) ion cross-linked copolymer thereof, and derivatives of these materials. These materials can be used singly or in combination of two or more. Among these materials, SBR is preferable.

Although the negative electrode material mixture layer may further include optional components such as conductive agents, the amount of the optional components included in the total negative electrode material mixture is preferably 3% by weight or less. For example, the negative electrode material mixture layer may include 0.5 to 2 parts by weight, preferably 0.5 to 1 part by weight of conductive agents per 100 parts by weight of the graphite particles. Preferable conductive agents are carbon black and carbon nanofiber.

As the negative electrode core material, a metal foil such as a copper foil and a copper alloy foil is used, for example. Among these materials, a copper foil (may contain 1% or less of trace components other than copper) is preferable, and an electrolytic copper foil is particularly preferable. In view of achieving the negative electrode core material with higher strength and the battery with higher energy density, the thickness of the metal foil is preferably 5 to 15 μm.

A non-aqueous electrolyte secondary battery of the present invention includes a negative electrode obtained by the above production method, a positive electrode capable of electrochemically absorbing and desorbing Li, a separator between the negative electrode and the positive electrode, and a non-aqueous electrolyte. The present invention is applicable to non-aqueous electrolyte secondary batteries of various shapes such as cylindrical, flat, coin, and prismatic types, and the shape of the battery is not particularly limited.

Along with repetition of the charge and discharge of the non-aqueous secondary battery, distortion stress of the graphite particles caused during compression of the negative electrode material mixture layer is relieved gradually, and the average circular degree of the graphite particles decreased by compression increases. In the present invention, since the degree of decrease of the average circular degree of the graphite particles during compression is reduced, the above distortion stress is small, and the degree of increase of the average circular degree of the graphite particles along with repetition of the charge and discharge is small. Therefore, change in shape of the graphite particles is small. Thus, it is possible to suppress separation of the graphite particles in the negative electrode material mixture layer from the negative electrode core material which is caused by an excessive increase of the average circular degree of the graphite particles along with repetition of the charge and discharge, such suppression permitting excellent charge/discharge cycle characteristics.

In charge/discharge cycle tests of the above non-aqueous electrolyte secondary battery, an increase ratio of the average circular degree of the graphite particles at the 100th cycle relative to the average circular degree of the initial (e.g. at the first cycle) graphite particle (increase ratio of the average circular degree at the 100th cycle, hereinafter) is preferably 20% or less. That is, the average circular degree of the graphite particles at the 100th cycle is preferably 120% or less of the average circular degree of the initial graphite particles.

The increase ratio of the average circular degree at the 100th cycle is determined by the following formula:

Increase ratio of the average circular degree at the 100th cycle (%)=(average circular degree of the graphite particles at the 100th cycle−average circular degree of the initial graphite particles)/average circular degree of the initial graphite particles×100

In this case, separation of the graphite particles from the negative electrode core material along with the charge/discharge cycles is suppressed, and the ratio of the discharge capacity at the 100th cycle relative to the initial capacity (e.g. discharge capacity at the first cycle) (capacity maintenance ratio at the 100th cycle, hereinafter) is 95% or more, permitting superior cycle characteristics.

Along with repetition of the charge and discharge of the non-aqueous electrolyte secondary battery, distortion stress of the graphite particles caused during compression of the negative electrode material mixture layer is relieved gradually and the average circular degree of the graphite particles decreased by the compression increases, thereby to increase the thickness of the negative electrode material mixture layer. In the present invention, since the degree of decrease of the average circular degree of the graphite particles during compression is reduced, the above distortion stress is small, and the degree of increase of the thickness of the negative electrode material mixture layer along with repetition of the charge and discharge is small. Therefore, it is possible to suppress separation of the graphite particles in the negative electrode material mixture layer from the negative electrode core material which is caused by an excessive increase of the thickness of the negative electrode material mixture layer due to an excessive increase of the average circular degree of the graphite particles along with repetition of the charge and discharge, such suppression permitting excellent charge/discharge cycle characteristics.

In charge/discharge cycle tests of the non-aqueous electrolyte secondary battery, an increase ratio of the thickness of the negative electrode material mixture layer at the 100th cycle relative to the thickness of the negative electrode material mixture layer at the first cycle (increase ratio of the thickness at the 100th cycle, hereinafter) is preferably 5% or less. That is, the thickness of the negative electrode material mixture layer at the 100th cycle is preferably 105% or less of the thickness of the negative electrode material mixture layer at the first cycle.

The increase ratio of the thickness at the 100th cycle is determined by the following formula:

Increase ratio of the thickness at the 100th cycle (%)=(thickness of the negative electrode material mixture layer at the 100th cycle−thickness of the negative electrode material mixture layer at the first cycle)/thickness of the negative electrode material mixture layer at the first cycle×100

In this case, separation of the graphite particles from the negative electrode core material along with the charge/discharge cycles is suppressed, and the capacity maintenance ratio at the 100th cycle is 95% or more, permitting superior cycle characteristics.

In cycle tests of the non-aqueous electrolyte secondary battery, the charge and discharge are repeated at 1 CA (1 hour rate).

As a specific example, conditions of a charge/discharge cycle test with a battery capacity of 850 mAh are shown as follows:

Constant current charge: charge current 850 mA, charge end voltage 4.2 V

Constant voltage charge: charge voltage 4.2 V, charge end current 100 mA

Constant current discharge: discharge current 850 mA, discharge end voltage 3 V

Rest time: 10 min

The positive electrode is not particularly limited as long as it can be used as a positive electrode of a non-aqueous electrolyte secondary battery. For example, the positive electrode can be produced by applying a positive electrode material mixture slurry including a positive electrode active material, a conductive agent such as carbon black, and a binder such as polyvinylidene fluoride onto a positive electrode core material such as an aluminum foil, and then drying and compressing the same. The positive electrode active material is preferably a lithium-containing transition metal oxide. Typical examples of the lithium-containing transition metal compound include LiCoO₂, LiNiO₂, LiMn₂O₄, LiMnO₂, LiNi_{1-y}Co_{y}O₂ (0<y<1), and LiNi_{1-y-z}Co_{y}Mn_{z}O₂ (0<y+z<1).

The non-aqueous electrolyte is preferably a liquid electrolyte including a non-aqueous solvent and a lithium salt dissolved therein. Generally used non-aqueous solvents are mixed solvents of cyclic carbonates such as ethylene carbonate and propylene carbonate with chain carbonates such as dimethyl carbonate, diethyl carbonate, and ethylmethyl carbonate. Also, γ-butyrolactone and dimethoxyethane are used. Examples of the lithium salt include inorganic lithium fluorides and lithium imide compounds. The inorganic lithium fluorides include LiPF₆ and LiBF₄, and the lithium imide compounds include LiN(CF₃SO₂)₂.

As the separator, a microporous film composed of polyethylene, polypropylene etc. is generally used. The separator has a thickness of 10 to 30 μm, for example.

### EXAMPLES

In the following, examples of the present invention will be described in detail, but the present invention is not limited to the following examples.

### Example 1

### (1) Production of Negative Electrode

3 kg of artificial graphite (manufactured by Mitsubishi Chemical Corporation, average particle diameter: 20 μm, average circular degree: 0.72) as a negative electrode active material, 75 g of BM-400B (aqueous dispersion containing 40% by weight of styrene-butadiene rubber (SBR)) manufactured by Zeon Corporation, 30 g of carboxymethyl cellulose (CMC), and an appropriate amount of water were stirred with a double-arm kneader to prepare a negative electrode slurry. This negative electrode slurry was applied onto both surfaces of a negative electrode core material composed of a copper foil having a thickness of 10 μm, and then dried to form negative electrode material mixture layers. Thus, a negative electrode precursor was obtained.

Subsequently, the negative electrode precursor was made to pass through a pair of heat rollers to be compressed. The time of compression was once. More specifically, the negative electrode precursor was compressed with a linear pressure of 1.5×10² kgf/cm while being heated to 80° C. with the heat rollers. At this time, the thickness of the negative electrode material mixture layer (one surface) was reduced from 120 μm to 67 μm. In this manner, the negative electrode having a total thickness of 144 μm was produced. The negative electrode was cut into strip shape having a width of 45 mm.

An elastic modulus at each temperature of SBR as the binder and ratio of the elastic modulus at each temperature relative to an elastic modulus at 25° C. are shown is Table 1. Herein, the elastic modulus refers to a storage elastic modulus.

TABLE 1

| | Elastic | Ratio of elastic modulus at |
|---|---|---|
| | modulus of | each temperature relative to |
| Temperature | SBR | elastic modulus at 25° C. |
| (° C.) | (MPa) | (%) |
| 25 | 1.7 × 10³ | 100 |
| 40 | 9.8 × 10² | 58 |
| 50 | 2.5 × 10² | 14 |
| 60 | 1.0 × 10² | 5.9 |
| 80 | 11 | 0.65 |
| 90 | 8.1 | 0.48 |
| 100 | 5.3 | 0.31 |
| 110 | 4.2 | 0.25 |

### (2) Production of Positive Electrode

3 kg of lithium cobaltate as the positive electrode active material, 0.6 kg of PVDF#7208 (solution of N-methyl-2-pyrrolidone (NMP, hereinafter) containing 8% by weight of PVDF) manufactured by Kureha Corporation, 90 g of acetylene black, and an appropriate amount of NMP were stirred with a double-arm kneader to prepare a positive electrode slurry. This positive electrode slurry was applied on both surfaces of a positive electrode core material composed of an aluminum foil having a thickness of 15 μm, and then dried to form a positive electrode material mixture layer. This positive electrode material mixture layer was compressed to produce a positive electrode having a total thickness of 152 μm. The positive electrode was cut into strip shape having a width of 43 mm.

### (4) Preparation of Non-Aqueous Electrolyte

LiPF₆ was dissolved, at a concentration of 1 mol/L, in a mixed solvent of ethylene carbonate (EC), dimethyl carbonate (DMC), and ethylmethyl carbonate (EMC) mixed in the volume ratio of 1:1:1 to prepare a non-aqueous electrolyte. The non-aqueous electrolyte was made to include 3% by weight of vinylene carbonate.

### (5) Assembly of Battery

A prismatic lithium ion secondary battery as shown in FIG. 1 was produced.

The negative electrode, the positive electrode, and a separator composed of a microporous film made of polyethylene having a thickness of 20 μm (A089 (trade name), manufactured by Celgard, LLC) arranged therebetween were wound up to form an electrode group 1 having a roughly oval cross section. The electrode group 1 was housed in a prismatic battery can 2 made of aluminum. The battery can 2 has a bottom portion, a side wall, and an open top portion, and has a roughly rectangular shape. Subsequently, an insulator 7 for preventing short circuiting of the battery can 2 with a positive electrode lead 3 or a negative electrode lead 4 was arranged on top of the electrode group 1. Next, a rectangular sealing plate 5 having a negative electrode terminal 6 surrounded by an insulating gasket 8 and a safety valve 10 was arranged in an opening of the battery can 2. The negative electrode lead 4 was connected to the negative electrode terminal 6. The positive electrode lead 3 was connected to a lower face of the sealing plate 5. An end portion of the opening of the battery can 2 was welded with the sealing plate 5 by laser to seal the opening of the battery can 2. Then, 2.5 g of the non-aqueous electrolyte was injected into the battery can 2 from an injection hole of the sealing plate 5. Finally, the injection hole was closed with a sealing tap 9 by welding to complete a prismatic lithium ion secondary battery having a height of 50 mm, a width of 34 mm, a thickness of about 5.4 mm, and a design capacity of 850 mAh.

### Comparative Example 1

A negative electrode was produced in the same manner as in Example 1 except that, in the step (2), the negative electrode precursor was compressed with a linear pressure of 4×10² kgf/cm without being heated such that the total thickness (density of the graphite particles) became the same as that of the negative electrode of Example 1. By using this negative electrode, a non-aqueous electrolyte secondary battery was produced in the same manner as in Example 1.

### Comparative Example 2

A negative electrode was produced in the same manner as in Example 1 except that, in the step (2), the negative electrode precursor was compressed without being heated. At this time, the total thickness of the negative electrode was 159 μm. By using this negative electrode, a non-aqueous electrolyte secondary battery was produced in the same manner as in Example 1.

The negative electrodes and the batteries of Example 1, and Comparative Examples 1 and 2 were evaluated as follows:

[Evaluations of Negative electrodes]
(1) Measurement of Weight of Graphite Particles Included Per 1 cm³ of Negative Electrode Active Material Layer (Density of Graphite Particles, Hereinafter)

An active material density was determined from the size (length, width, and thickness) of the negative electrode material mixture layer and the weight of the graphite particles by using the following formula:

Density of the graphite particles (g/cm³)=weight of the graphite particles (g)/volume of the negative electrode material mixture layer (cm³)

### (2) Measurement of Average Circular Degree of Graphite Particles Before and After Compression

The cross section of the negative electrode material mixture layer was observed with a scanning electron microscope (SEM) and an average circular degree of the graphite particles in the negative electrode material mixture layer was determined.

Specifically, by image processing of SEM, any 100 graphite particles having an equivalent circle diameter corresponding to the average particle diameter were abstracted, circular degrees of the same were determined, and the average value thereof was determined. The equivalent circle diameter is a diameter of a circle having the same surface area as the surface area of the two-dimensional projected image of a particle.

The circular degree was determined by the following formula:

Circular degree=(circumference of a circle having the same surface area as the two-dimensional projected image of a particle)/(effective circumference of the two-dimensional projected image of the particle)

The average particle diameter of the graphite particles was determined, by image processing of SEM, as an average value of the diameters of any abstracted 100 graphite particles in the negative electrode material mixture layer. When the average particle diameter of the graphite particles was determined, graphite particles having a particle diameter of 1 μm or less were eliminated. Measurements were made at selected 3 portions with one graphite particle and an average value of the measured values was defined as the particle diameter of the graphite particle.

### (3) Measurement of Decrease Ratio of Average Circular Degree of Graphite Particles in Compression Step

A decrease ratio of the average circular degree of the graphite particles during compression was determined by the following formula:

Decrease ratio of the average circular degree of the graphite particles during compression (%)=(average circular degree of the graphite particles before compression−average circular degree of the graphite particles after compression)/average circular degree of the graphite particles before compression×100

### (4) Measurement of Compression Ratio

Thicknesses of the negative electrode material mixture layer before and after compression of the graphite particles were measured, and a compression ratio was determined by the following formula:

Compression ratio (%)=thickness of the negative electrode material mixture layer after compression/thickness of the negative electrode material mixture layer before compression×100

### [Evaluation of Prismatic Battery]

### (1) Evaluation of Charge/Discharge Cycle Characteristics

An initial capacity was determined by charging and discharging in an environment at 20° C. under the following conditions. Subsequently, the charge and discharge were repeated for 100 cycles in an environment at 20° C. under the following conditions, and a discharge capacity at the 100th cycle was determined. A capacity maintenance ratio at the 100th cycle was determined by the following formula:

Capacity maintenance ratio at the 100th cycle (%)=discharge capacity at the 100th cycle/discharge capacity at the first cycle×100

### <Charge/Discharge Conditions>

Constant current charge: charge current 850 mA, charge end voltage 4.2 V

Constant voltage charge: charge voltage 4.2 charge end current 100 mA

Constant current discharge: discharge current 850 mA, discharge end voltage 3V

Rest time: 10 min

### (2) Measurement of Change in Average Circular Degree of Graphite Particles at Charge/Discharge Cycles

An increase ratio of the average circular degree of the graphite particles at the 100th cycle was determined by the following formula:

Increase ratio of the average circular degree of the graphite particles at the 100th cycle=(average circular degree of the graphite particles at the 100th cycle−average circular degree of the graphite particles at the first cycle)/average circular degree of the graphite particles at the first cycle×100

### (3) Measurement of Change in Thickness of Negative Electrode Material Mixture Layer at Charge/Discharge Cycles

An increase ratio of the thickness of the negative electrode material mixture layer at the 100th cycle was determined by the following formula:

Increase ratio of the thickness of the negative electrode material mixture layer at the 100th cycle=(thickness of the negative electrode material mixture layer at the 100th cycle−thickness of the negative electrode material mixture layer at the first cycle)/thickness of the negative electrode material mixture layer at the first cycle×100

Evaluation results are shown in Table 2.

TABLE 2

| | | | | | | | Charge-discharge cycle | | |
|---|---|---|---|---|---|---|---|---|---|
| | | | | | | | characteristics | | |
| | | | | | | | (at 100th Cycle) | | |
| | | | | | | | | Increase | |
| | | | Decrease | | | | Increase | ratio of | |
| | | | ratio of | | | | ratio of | thickness | |
| | | | average | | | | average | of | |
| | Compression step (2) | | circular | Density | Thickness | | circular | negative | |
| | Liner | | degree | of | of | | degree of | electrode | Capacity |
| | pressure | Heating | during | graphite | negative | Compression | graphite | material | maintenance |
| | (×10² | temperature | compression | particles | electrode | ratio | particles | mixture | ratio |
| | kgf/cm) | (° C.) | (%) | (g/cm³) | (μm) | (%) | ( %) | layer | (%) |
| Com. Ex. l | 4 | No heating | 36 | 1.56 | 144 | 58 | 25 | 10 | 92 |
| Com. Ex. 2 | 1.5 | No heating | 14 | 1.45 | 159 | 64 | 13 | 8 | 94 |
| Ex. l | 1.5 | 80 | 14 | 1.56 | 144 | 58 | 11 | 3 | 98 |

In the battery using the negative electrode of Example 1 in which the density of the graphite particles was 1.5 g/cm³ or more and the decrease ratio of the average circular degree of the graphite particles during compression was 14%, excellent charge/discharge cycle characteristics were obtained as compared to the batteries using the negative electrodes of Comparative Examples 1 and 2.

In Comparative Example 1, since the negative electrode precursor was not heated during compression, the linear pressure during compression was higher than in Example 1 when the negative electrode precursor was compressed so as to have the same thickness of the negative electrode (density of the graphite particles) as that of Example 1. As a result, the graphite particles deformed greatly, the decrease ratio of the average circular degree of the graphite particles during compression increased, thereby deteriorating the charge/discharge cycle characteristics.

In Comparative Example 2, since the negative electrode precursor was not heated during compression, when the negative electrode precursor was compressed with the same linear pressure as in Example 1, the binder did not penetrate between the graphite particles sufficiently, thereby deteriorating the binding properties between the graphite particles in the negative electrode material mixture layer and lowering the charge/discharge cycle characteristics.

### Example 2

Negative electrodes were produced in the same manner as in Example 1 except that, in the step (2), the linear pressure was 2.0×10² kgf/cm and the heating temperature was changed to the values shown in Table 3. By using these negative electrodes, batteries were produced in the same manner as in Example 1. The negative electrodes and the batteries were evaluated in the aforementioned manner. Evaluation results are shown in Table 3.

TABLE 3

| | | | | | | Charge-discharge cycle | | |
|---|---|---|---|---|---|---|---|---|
| | | | | | | characteristics | | |
| | | Decrease | | | | (at 100th cycle) | | |
| | | ratio of | | | | | Increase | |
| | | average | | | | Increase | ratio of | |
| | | circular | | | | ratio of | thickness | |
| | | degree of | | | | average | of | |
| | Heating | graphite | Density | Thickness | | circular | negative | |
| | temperature | particles | of | of | | degree of | electrode | Capacity |
| Battery | during | during | graphite | negative | Compression | graphite | material | maintenance |
| (negative | compression | compression | particles | electrode | ratio | particles | mixture | ratio |
| electrode) | (° C.) | (%) | (g/cm³) | (μm) | (%) | (%) | layer | (%) |
| A | 40 | 19 | 1.48 | 156 | 62 | 17 | 6 | 95 |
| B | 50 | 19 | 1.55 | 149 | 60 | 15 | 4 | 97 |
| C | 60 | 19 | 1.57 | 147 | 59 | 14 | 3 | 98 |
| D | 90 | 19 | 1.65 | 140 | 56 | 15 | 4 | 97 |
| E | 100 | 19 | 1.69 | 137 | 55 | 15 | 5 | 95 |

In the negative electrodes B to E, the density of the graphite particles in the negative electrode material mixture layer was 1.5 g/cm³ or more and the decrease ratio of the average circular degree of the graphite particles during compression was 20% or less. In the batteries B to E in which the heating temperature in the step (2) was 50 to 100° C., a negative electrode in which the graphite particles in the negative electrode material mixture layer had a high density could be obtained, and excellent charge/discharge cycle characteristics were obtained.

### Example 3

Negative electrodes were produced in the same manner as in Example 1 except that, in the step (2), the heating temperature was 80° C. and the liner pressure was changed to the values shown in Table 4. By using these negative electrodes, batteries were produced in the same manner as in Example 1. The negative electrodes and the batteries were evaluated in the aforementioned manner. Evaluation results are shown in Table 4.

TABLE 4

| | | | | | | Charge/discharge cycle | | |
|---|---|---|---|---|---|---|---|---|
| | | | | | | characteristics | | |
| | | Decrease | | | | (at 100th Cycle) | | |
| | | ratio of | | | | | Increase | |
| | | average | | | | | ratio of | |
| | | circular | | | | Increase | thickness | |
| | | degree of | | | | ratio of | of | |
| | | graphite | Density | Thickness | | average | negative | |
| | Pressure | particles | of | of | | circular | electrode | Capacity |
| Battery | during | during | graphite | negative | Compression | degree of | material | maintenance |
| (negative | compression | compression | particles | electrode | ratio | graphite | mixture | ratio |
| electrode) | (×10² kgf/cm) | (% ) | (g/cm³) | (μm) | (%) | particles | layer | (%) |
| F | 0.7 | 11 | 1.49 | 155 | 62 | 8 | 7 | 97 |
| G | 1.0 | 14 | 1.54 | 150 | 60 | 8 | 5 | 98 |
| H | 2.0 | 19 | 1.61 | 144 | 58 | 14 | 3 | 97 |
| I | 2.5 | 21 | 1.65 | 140 | 56 | 18 | 3 | 96 |
| J | 3.0 | 27 | 1.69 | 137 | 55 | 20 | 4 | 95 |
| K | 3.3 | 32 | 1.74 | 134 | 54 | 25 | 8 | 89 |

In the negative electrodes G to J, the density of the graphite particles in the negative electrode material mixture layer was 1.5 g/cm³ or more, and the decrease ratio of the average circular degree of the graphite particles during compression was 30% or less. In batteries G to J in which the linear pressure in the step (2) was 1.0×10² to 3.0×10² kgf/cm, a negative electrode in which the graphite particles in the negative electrode material mixture layer had a high density and excellent charge/discharge cycle characteristics were obtained.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### INDUSTRIAL APPLICABILITY

The negative electrode of the present invention is used suitably in non-aqueous electrolyte secondary batteries such as prismatic type. The non-aqueous electrolyte secondary battery of the present invention is suitably used as a power source for electronic devices such as information apparatuses because of having superior initial characteristics and charge/discharge cycle characteristics.

1. A method of producing a negative electrode for non-aqueous electrolyte secondary battery, comprising the steps of:
(1) producing a negative electrode precursor by applying a negative electrode slurry including graphite particles and a binder onto a negative electrode core material and drying the same to form a negative electrode material mixture layer; and
(2) producing a negative electrode by compressing while heating said negative electrode precursor at a temperature at which said binder softens,
wherein, in said step (2), a temperature at which said negative electrode precursor is heated and a force with which said negative electrode precursor is compressed are controlled such that said compressed negative electrode material mixture layer in said negative electrode includes 1.5 g or more of said graphite particles per 1 cm³ said negative electrode material mixture layer, and that an average circular degree of said graphite particles maintains 70% or more of an average circular degree of graphite particles in said negative electrode precursor.

2. The method of producing a negative electrode for non-aqueous electrolyte secondary battery in accordance with claim 1, wherein the temperature at which said negative electrode precursor is heated is a temperature at which an elastic modulus of said binder is 30% or less of an elastic modulus of said binder at 25° C.

3. The method of producing a negative electrode for non-aqueous electrolyte secondary battery in accordance with claim 1, wherein the temperature at which said negative electrode precursor is heated is 50 to 100° C.

4. The method of producing a negative electrode for non-aqueous electrolyte secondary battery in accordance with claim 1, wherein the force with which said negative electrode precursor is compressed is 1×10² to 3×10² kgf/cm.

5. A negative electrode for non-aqueous electrolyte secondary battery obtained by the production method in accordance with claim 1.

6. A negative electrode for non-aqueous electrolyte secondary battery, comprising:
a negative electrode core material; and
a compressed negative electrode material mixture layer including graphite particles and a binder on said negative electrode core material,
wherein said negative electrode material mixture layer includes 1.5 g or more of said graphite particles per 1 cm³ of said negative electrode material mixture layer, and
an average circular degree of said graphite particles maintains 70% or more of that before compression.

7. The negative electrode for non-aqueous electrolyte secondary battery in accordance with claim 6,
wherein said negative electrode material mixture layer includes 1.6 g or more of said graphite particles per 1 cm³ of said negative electrode material mixture layer, and
an average circular degree of said graphite particles is 0.7 or more.

8. The negative electrode for non-aqueous electrolyte secondary battery in accordance with claim 6,
wherein said negative electrode core material comprises a metal foil,
said negative electrode material mixture layer is on both surfaces of said metal foil, and
said negative electrode material mixture layer has a thickness per one surface of 60 to 80 μm.

9. A non-aqueous electrolyte secondary battery comprising:
the negative electrode in accordance with claim 6;
a positive electrode including a positive electrode active material;
a separator between said positive electrode and said negative electrode; and
a non-aqueous electrolyte.

10. The non-aqueous electrolyte secondary battery in accordance with claim 9, wherein, in a charge/discharge cycle test, an increase ratio of an average circular degree of said graphite particles at the 100th cycle relative to an average circular degree of said graphite particles at the first cycle is 20% or less.

11. The non-aqueous electrolyte secondary battery in accordance with claim 9, wherein, in a charge/discharge cycle test, an increase ratio of a thickness of said negative electrode material mixture layer at the 100th cycle relative to a thickness of said negative electrode material mixture layer at the first cycle is 5% or less.
